(19) United States
(12) Patent Application Publication
(10) Pub. No.: US 2022/0183319 A1
(43) Pub. Date: Jun. 16, 2022

(54) DOG TREATS AND PROCESS OF MAKING SAME

(71) Applicants: JOHANNES HOEGER, PUNTA GORDA, FL (US); ASTRID HEDWIG HOEGER, PUNTA GORDA, FL (US); BIANCA ROMINA HOEGER, KALL (DE); JEAN MARTIN HOEGER, KALL (DE)

(72) Inventors: JOHANNES HOEGER, PUNTA GORDA, FL (US); ASTRID HEDWIG HOEGER, PUNTA GORDA, FL (US); BIANCA ROMINA HOEGER, KALL (DE); JEAN MARTIN HOEGER, KALL (DE)

(21) Appl. No.: 17/123,281

(22) Filed: Dec. 16, 2020

(51) Int. Cl. A23K 10/20; A23K 40/20; A23K 50/42; A23K 10/14; A23K 20/22; A23K 10/30

(52) U.S. Cl. CPC A23K 10/20; A23K 40/20; A23K 10/30; A23K 10/14; A23K 20/22; A23K 50/42

(57) ABSTRACT

A dog treat made from a dairy based product, preferably milk having a fat content of approximately one percent, which is heated with other ingredients and pressed and hardened into a desired configuration to form a hardened cheese-like dog treat.

### FIELD OF THE INVENTION

This invention relates to dog treats and more particularly to a dog treat made from milk and the process for making same.

### BACKGROUND OF THE INVENTION

Current dog treats often lack the nutrition necessary to foster and maintain good health of a dog. In addition many dog treats are made of artificial ingredients, rather than natural. Furthermore, many dog treats and bones are too hard or difficult for a dog to chew and digest. In addition, some dog treats are not very desirable to a dog.

Therefore, a need exists for a dog treat made from nutritious natural ingredients that is easy to chew and digest and is very desirable to a dog.

### SUMMARY OF THE INVENTION

The primary object of the present invention is to provide a dog treat that is nutritious to dogs of all ages.

Another object of the present invention is to provide such a dog treat that is made from natural ingredients.

Even another object of the present invention is to provide such a dog treat that is easy for a dog to chew and digest Another object of the present invention is to provide such a dog treat that is rich in calcium and protein.

Another object of the present invention is to provide such a dog treat with natural flavor or natural ingredients.

Another object of the present invention is to provide such dog treat that is loved by dogs.

An even further object of the present invention is to provide a process for making such a dog treat.

The present invention fulfills the above and other objects by providing a dog treat having a dairy base, such as fresh milk or milk powder that is made through a special process into a hard cheese dog treat. The process of making said dog treat begins with fresh milk and/or milk powder from a group of milks, including cow, goat, camel, almond or mixture thereof, and so forth. The milk and/or milk powder is added into water which has been heated to 32 degrees Celsius. The ratio of fat-free and full-fat milk in the fresh milk or milk powder can be varied depending on the hardness and consistency of the ultimate dog treat. Cheese coloring, such as annatto, and calcium chloride are added to the mix. Also, possible flavoring ingredients like bacon, beef jerky, peanut butter, fruits and so forth may be added. The milk solution is then made into buttermilk by adding lemon juice or vinegar. With the help of enzymes, cheese curd is formed from the buttermilk over a waiting time of approximately 45 minutes. The resulting curd is cut and cooked for approximately 20 minutes at a temperature over 80 degrees Celsius while adding a small amount of salt. Again, flavoring ingredients, such as bacon, beef jerky, peanut butter, fruits and so forth may be added in this step of the process. The curd is then pre-pressed under whey to remove trapped air into a preformed body and wrapped in a cheesecloth and pressed hard for one to two days. Then the preformed body is cut into sticks and pressed from the opposite side for one day to reduce formation of cracks on the cut sides. A block mold in a desired shape, such as a bone or stick, can be used for hard pressing. This bone or stick is then stored in cool place and packed and sold. Alternatively, the resulting stick is then chilled and dried for one week to three months to create different hardness levels. The surface of the bone or stick can be refined in an additional refinement process by placing it in hot highly concentrated milk for a few minutes to refine the surface.

The above and other objects, features and advantages of the present invention should become even more readily apparent to those skilled in the art upon a reading of the following detailed description in conjunction with the drawings wherein there is shown and described illustrative embodiments of the invention.

### DESCRIPTION OF THE DRAWINGS

In the following detailed description, reference will be made to the attached drawings in which:

FIG. 1 is a perspective view of the sample dog treat of the present invention in the form of a stick;

FIG. 2A is a schematic flow chart of the process of making the dog treat of the present invention; and

FIG. 2B is a continuation of the schematic flow chart of FIG. 2A of the process of making the dog treat of the present invention.

Referring now to the drawings, FIG. 1 shows a perspective view of the dog treat generally 1 having a preformed stick-like body 2 made of hardened cheese.

FIG. 2 illustrates in block flow chart fashion the process involved in making the dog treat of the present invention. The first step 3 in the process is to heat water or milk to 32 degrees Celsius. The second step 4 is to add milk powder to the heated water and continue heating at 32 degrees Celsius. The milk should have a fat content of one percent plus or minus 0.7% to achieve the best results. The milk or milk powder may come from cows, goats, other mammal or even almond.

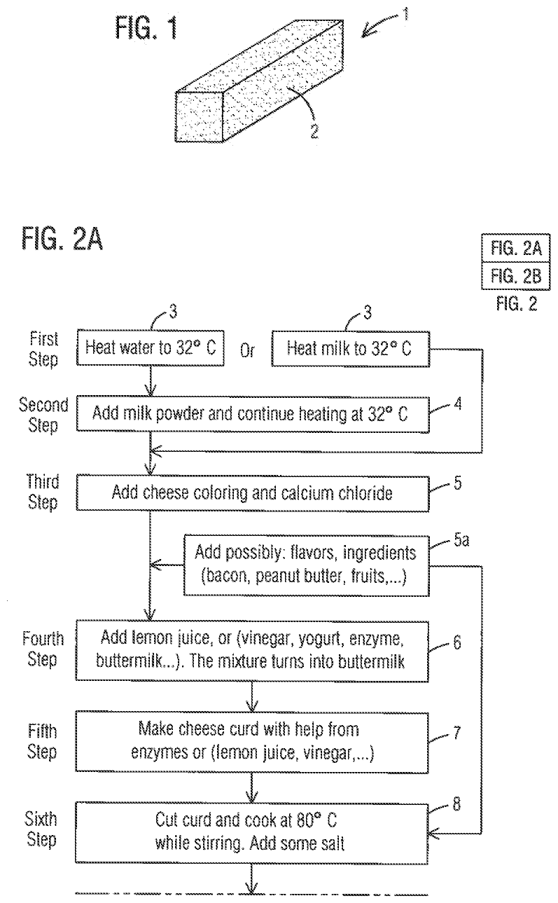

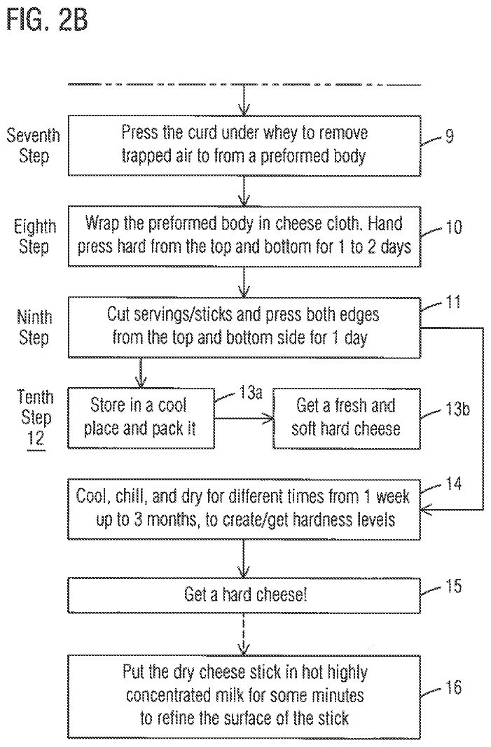

The third step 5 is to add cheese coloring, namely annatto, and calcium chloride. An optional secondary part 5a of the third step may include adding flavoring agents, like bacon, beef jerky, peanut butter, fruits and so forth.

The fourth step 6 is to add lemon juice and continue heating until the mixture becomes buttermilk. The fifth step 7 is to add enzymes and continue until curd is formed. Once curd is formed in the fifth step 7 it is cut, stirred and cooked at greater than 80 degrees Celsius while adding some salt. As part of this step just like in step 5a, flavoring ingredients, such as bacon, beef jerky, peanut butter, fruits and so forth may be added.

In the seventh step 9 the curd is pressed under whey to remove trapped air to form a preformed body. Then in the eighth step 10 the preformed body is wrapped in cheese cloth and pressed hard on one side for 1 to 2 days. Then in the ninth step 11 the preformed body is cut into servings, such as sticks, which are pressed hard on the other side for a day. Molds may be used in the eighth and ninth steps to shape the preformed body.

Finally, in the tenth step 12, the process is divided in two ways. One way 13a and 13b is for the soft, but hard cheese sticks to be stored in a cool place and then packed for sale. The second way 14 is for the sticks to be chilled and dried in a cool place, for different times from one week to three months to create cheese sticks with various hardness levels to form a hardened cheese dog treat 15.

An optional step in the process is a refining step 16 by which any rough surfaces of the hardened cheese dog treat is made smoother. In this step the hardened cheese treat is placed in highly concentrated milk for several minutes to refine the surface of the treat.

It is to be understood that while a preferred embodiment of the invention is described, it is not to be limited to the specific form or arrangement of parts herein described and shown. It will be apparent to those skilled in the art that various changes may be made without departing from the scope of the invention and the invention is not to be considered limited to what is shown and described in the specification and/or drawings.

Having thus described our invention, we claim:

1. A dog treat comprising:
a dairy based material that is thickened with an addition of lemon juice and hardened and shaped into a desired configuration through pressing to form a cheese dog treat.

2. The dog treat of claim 1 wherein the dairy based material comprises milk having a fat content of one percent plus or minus 0.7%.

3. The dog treat of claim 1 wherein the dairy based material is milk.

4. A process for making a dog treat said process comprising the steps of:
a. heating a mixture of water and milk powder or milk to a temperature of 32 degrees Celsius;
b. adding annatto and calcium chloride;
c. adding lemon juice and mixing the mixture until buttermilk is formed;
d. adding enzymes until the buttermilk is formed into a curd;
e. cutting the curd and cooking it for approximately twenty minutes while adding a bit of salt;
f. pressing the curd under whey to remove trapped air;
g. forming the curd into a predetermined configuration of the treat;
h. wrapping the curd in a cheesecloth and pressing hard on one side for one to two days;
i. cutting the curd into sticks and pressing said sticks from another side for one day; and
j. chilling and drying the stick for approximately one week to three months.

5. The process of claim 4 wherein the dairy based material is milk.

6. The process of claim 4 wherein the dairy based material is powdered milk.

7. The process of claim 4 wherein steps b. and c. further comprise adding flavoring ingredients.

8. The process of claim 4 further comprising a step after step j. wherein the surface of the dog treat is refined by placing it in hot highly concentrated milk for a few minutes to yield a smoother surface.

9. The process of claim 4 wherein steps b. and c. further comprise adding natural ingredients.
